(19) United States
(12) Patent Application Publication
(10) Pub. No.: US 2010/0080299 A1
(43) Pub. Date: Apr. 1, 2010

(54) FRAME FREQUENCY CONVERSION APPARATUS, FRAME FREQUENCY CONVERSION METHOD, PROGRAM FOR ACHIEVING THE METHOD, COMPUTER READABLE RECORDING MEDIUM RECORDING THE PROGRAM, MOTION VECTOR DETECTION APPARATUS, AND PREDICTION COEFFICIENT GENERATION APPARATUS

(75) Inventors: Naoki TAKEDA, Tokyo (JP); Tetsujiro KONDO, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: SONY CORPORATION, Tokyo (JP)

(21) Appl. No.: 12/554,383

(22) Filed: Sep. 4, 2009

(30) Foreign Application Priority Data
Sep. 30, 2008 (JP) 2008-255108

(51) Int. Cl. H04N 7/26

(52) U.S. Cl. 375/240.16; 375/E07.125

(57) ABSTRACT

A frame-frequency conversion apparatus includes: a motion estimation section inputting a first and a second frames of a low-frequency image signal and estimating a plurality of candidate vectors indicating motions between the frames; a first pixel generation section generating a predicted pixel of a predicted frame corresponding to the second frame for each vector; a motion allocation section obtaining a correlation between the predicted pixel of the predicted frame and a second-frame pixel, selecting a candidate vector of a high-correlation predicted pixel, and allocating the selected candidate vector to a pixel of an interpolated frame interpolating the first and the second frames to determine the vector to be an allocated vector; a motion compensation section allocating a neighboring allocated vector to a vector-not-allocated pixel of the interpolated frame; and a second pixel generation section generating a pixel of the interpolated frame and outputting a high-frequency image signal.

### BACKGROUND OF THE INVENTION

1. Field of the Invention

The present invention relates to a frame-frequency conversion apparatus which converts a frame (or field) frequency of a moving image, etc. More particularly, in the present invention, a predicted pixel of a predicted frame corresponding to an existing frame is generated from a pixel determined by a candidate vector. And correlations between individual predicted pixels of the generated predicted frame and the pixels having the same positions in the existing frame are obtained, and a candidate vector of the predicted pixel having the high correlation is selected. In this manner, the present invention makes it possible to select an optimum candidate vector out of a plurality of the candidate vectors, and to correctly detect a motion vector on a boundary of an object in an image.

2. Description of the Related Art

To date, as a method of converting a frame (or field) frequency of a moving image, motions between frames have been estimated, and a new frame has been generated using the estimated motion quantities. For example, a motion-vector detection apparatus has been disclosed in Japanese Unexamined Patent Application Publication No. 2005-175872 (page 14). In the motion-vector detection apparatus, a motion vector is obtained by a combination of representative point matching and block matching. For example, a plurality of candidate vectors are extracted by representative point matching. And a correlation between a block including pixels of start points of individual candidate vectors and a block including pixels of end points is determined by block matching. A candidate vector related to a block having a highest correlation is determined to be a motion vector.

### SUMMARY OF THE INVENTION

In the motion-vector detection apparatus described in Japanese Unexamined Patent Application Publication No. 2005-175872 (page 14), a motion vector is determined from a plurality of candidate vectors by block matching. In block matching, a correlation is determined for each block including a plurality of pixels. Accordingly, boundaries of an object in an image may be mistakenly detected, and thus a motion vector may not be correctly detected.

The present invention addresses the above described and other problems. It is desirable to provide a frame-frequency conversion apparatus, a frame-frequency conversion method, a program for achieving the method, a computer-readable recording medium recording the program, a motion-vector detection apparatus, and a prediction-coefficient generation apparatus which allow selecting an optimum candidate vector from a plurality of candidate vectors, and correctly detecting a motion vector on a boundary of an object in an image.

According to an embodiment of the present invention, there is provided a frame-frequency conversion apparatus including: a motion-estimation section inputting a first frame and a second frame of an image signal having a low frequency and estimating a plurality of candidate vectors indicating motions between the first frame and the second frame; a first-pixel generation section generating a predicted pixel of a predicted frame corresponding to the second frame for each of the candidate vectors from a pixel determined by the candidate vector estimated by the motion estimation section; a motion allocation section obtaining a correlation between the individual predicted pixel of the predicted frame and a pixel of the second frame, selecting a candidate vector of a predicted pixel having a high value in the correlation, and allocating the selected candidate vector to an individual pixel of an interpolated frame interpolating the first frame and the second frame to determine the vector to be an allocated vector; a motion compensation section allocating a neighboring allocated vector to a pixel of the interpolated frame to which an allocated vector has not been allocated by the motion allocation section; and a second-pixel generation section generating a pixel of the interpolated frame from a pixel determined by the allocated vector and outputting an image signal having a high frequency.

In the frame-frequency conversion apparatus according to the present invention, the motion estimation section estimates a plurality of candidate vectors indicating motions between the first frame and the second frame. For example, a representative-point-matching processing section of the motion estimation section determines a representative point in one of the first frame and the second frame, and sets a search area corresponding to the representative point in the other of the first frame and the second frame. And correlations between the pixel values of individual pixels included in the search area and the pixel value of the representative point are obtained, and the evaluation values are set in an evaluation value table. An evaluation-value-table forming section accumulates the evaluation values set by the representative-point-matching processing section for all the representative points, and forms an evaluation value table. A candidate-vector extraction section extracts a motion quantity having a high evaluation value from the evaluation value table as a candidate vector.

The first pixel generation section generates a predicted pixel of a predicted frame corresponding to the second frame for each of the candidate vectors from a pixel determined by the candidate vector estimated by the motion estimation section. For example, the first-motion-class determination section of the first pixel generation section preferably determines a motion class including a predicted pixel from the candidate vector. A first-prediction-coefficient selection section preferably selects a prediction coefficient having been obtained in advance for each motion class determined by the first-motion-class determination section and minimizing an error between a student image corresponding to the predicted frame and a teacher image corresponding to the second frame. The first-prediction-tap selection section preferably selects a plurality of pixels located in the surroundings of the predicted pixel of the predicted frame at least from the first frame. The first calculation section preferably calculates a prediction coefficient selected by the first-prediction-coefficient selection section and the plurality of pixels selected by the first-prediction-tap selection section to generate a predicted pixel of the predicted frame.

The motion allocation section preferably obtains a correlation between the individual predicted pixel of the predicted frame and a pixel of the second frame, and preferably selects a candidate vector of a predicted pixel having a high value in the correlation. Thus, it is possible to select an optimum candidate vector from the plurality of the candidate vectors. The motion allocation section preferably allocates the selected candidate vector to an individual pixel of an interpolated frame interpolating the first frame and the second frame to determine the vector to be an allocated vector.

The motion compensation section preferably allocates a neighboring allocated vector to a pixel of the interpolated frame to which the allocated vector has not been allocated by the motion allocation section. The second-pixel generation section preferably generates a pixel of the interpolated frame from a pixel determined by the allocated vector and outputs an image signal having a high frequency.

According to another embodiment of the present invention, there is provided a method of converting a frame frequency, the method including the steps of: inputting a first frame and a second frame of an image signal having a low frequency and estimating a plurality of candidate vectors indicating motions between the first frame and the second frame; generating a predicted pixel of a predicted frame corresponding to the second frame for each of the candidate vectors from a pixel determined by the estimated candidate vector; obtaining a correlation between the individual predicted pixel of the predicted frame and a pixel of the second frame and selecting a candidate vector of a predicted pixel having a high value in the correlation; allocating the selected candidate vector to an individual pixel of an interpolated frame interpolating the first frame and the second frame to determine the vector to be an allocated vector; allocating a neighboring allocated vector to a pixel of the interpolated frame to which the allocated vector has not been allocated by the motion allocation section; and generating a pixel of the interpolated frame from a pixel determined by the allocated vector and outputting an image signal having a high frequency.

According to another embodiment of the present invention, there is provided a program for causing a computer to perform a method of converting a frame frequency. Also, according to another embodiment of the present invention, there is provided a computer readable recording medium recording the above-described program.

According to another embodiment of the present invention, there is provided a motion-vector detection apparatus including: a motion-estimation section inputting a first frame and a second frame of an image signal having a low frequency and estimating a plurality of candidate vectors indicating motions between the first frame and the second frame; a first-motion-class determination section determining a motion class including a predicted pixel of a predicted frame corresponding to the second frame from the candidate vector; a first-prediction-coefficient selection section selecting a prediction coefficient having been obtained in advance for each motion class determined by the first-motion-class determination section and minimizing an error between a student image corresponding to the predicted frame and a teacher image corresponding to the second frame; a first-prediction-tap selection section selecting a plurality of pixels located in the surroundings of the predicted pixel of the predicted frame at least from the first frame; a first calculation section calculating a prediction coefficient selected by the first-prediction-coefficient selection section and the plurality of pixels selected by the first-prediction-tap selection section to generate a predicted pixel of the predicted frame; and a motion allocation section obtaining a correlation between individual predicted pixel of the predicted frame and a pixel of the second frame, and detecting a candidate vector of the predicted pixel having a high correlation to be a motion vector.

According to another embodiment of the present invention, there is provided a prediction-coefficient generation apparatus including: a motion-estimation section inputting a first frame and a second frame of an image signal having a low frequency and estimating a plurality of candidate vectors indicating motions between the first frame and the second frame; a motion-class determination section determining a motion class including a predicted pixel of a predicted frame corresponding to the second frame as a teacher image from the motion vector; a prediction-tap selection section selecting a plurality of pixels located in the surroundings of the predicted pixel of the predicted frame at least from the first frame as a student image; and a prediction-coefficient generation section obtaining a prediction coefficient minimizing an error between a plurality of pixels in the student image and pixels of the teacher image for each motion class from the motion class detected by the motion-class determination section, the plurality of pixels of the student image selected by the prediction-tap selection section and the pixels of the teacher image.

By the present invention, a predicted pixel of a predicted frame corresponding to an existing frame is generated from a pixel determined by a candidate vector. And correlations between individual predicted pixels of the generated predicted frame and the pixels having the same positions in the existing frame are obtained, and a candidate vector of the predicted pixel having the high correlation is selected.

With this arrangement, it is possible to select an optimum candidate vector out of a plurality of the candidate vectors. Furthermore, a correlation is obtained for each pixel, and thus it becomes possible to more correctly detect a motion vector on a boundary of an object in an image compared with a method of obtaining a correlation for each block.

### BRIEF DESCRIPTION OF THE DRAWINGS

FIG. 1 is a block diagram illustrating an example of a configuration of a frame-frequency conversion apparatus 100 according to an embodiment of the present invention;

FIG. 2 is a block diagram illustrating an example of a configuration of a motion estimation section 3;

FIGS. 3A and 3B are schematic diagrams illustrating an example of a representative-point matching method;

FIG. 4 is a block diagram illustrating an example of a configuration of a pixel generation section 4;

FIG. 5 is a schematic diagram illustrating an example of generation of a predicted pixel P4 in a predicted frame F;

FIG. 6 is a schematic diagram illustrating an example of selection of a candidate vector;

FIG. 7 is a schematic diagram illustrating an example of generation of an allocated vector;

FIG. 8 is a block diagram illustrating an example of a configuration of a pixel generation section 7;

FIG. 9 is a flowchart illustrating an example of an operation of the frame-frequency conversion apparatus 100;

FIG. 10 is a flowchart illustrating generation processing of the predicted frame F;

FIG. 11 is a flowchart illustrating motion compensation processing;

FIG. 12 is a block diagram illustrating an example of a configuration of a prediction-coefficient generation apparatus 50;

FIG. 13 is a block diagram illustrating an example of a configuration of a prediction-coefficient generation apparatus 51; and

FIG. 14 is a block diagram illustrating an example of a configuration of a computer 70 to which the present invention is applied.

### DESCRIPTION OF THE PREFERRED EMBODIMENTS

Next, a description will be given of an embodiment of the present invention with reference to the drawings. In this regard, the description will be given in the following sequence.

1. First embodiment (frame interpolation using class grouping adaptive processing)

2. Second embodiment (generation of prediction coefficients)

### First Embodiment

Frame interpolation using class grouping adaptive processing

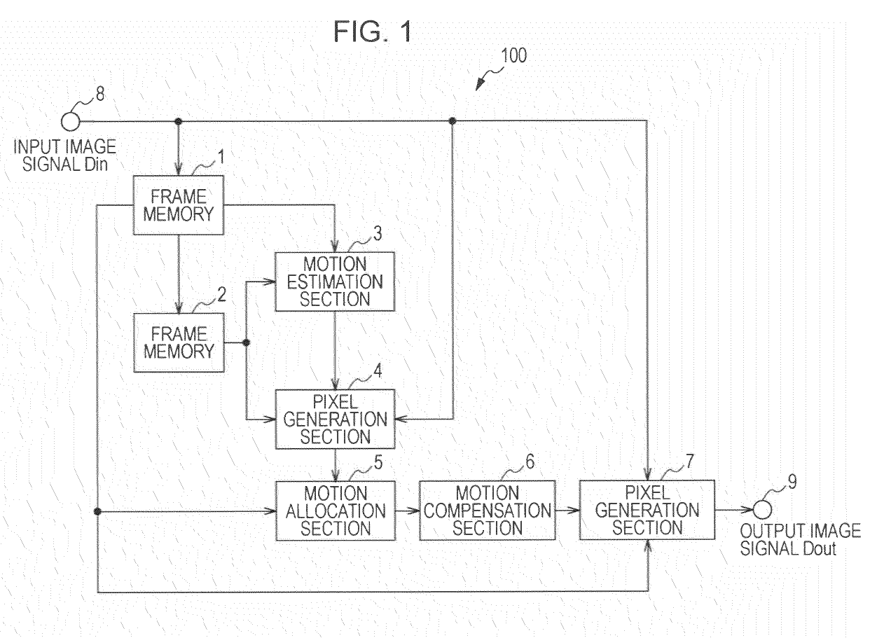

FIG. 1 is a block diagram illustrating an example of a configuration of a frame-frequency conversion apparatus 100 according to an embodiment of the present invention. In this example, a method of obtaining a motion vector is the same both for a frame of a progressive signal and a field of interlace signal, and thus a frame is used.

The frame-frequency conversion apparatus 100 shown in FIG. 1 includes frame memories 1 and 2, a motion estimation section 3, a pixel generation section 4, a motion allocation section 5, a motion compensation section 6, a pixel generation section 7, an input terminal 8, and an output terminal 9.

An input image signal Din having been input into the input terminal 8 is supplied to the frame memory 1 and the pixel generation sections 4 and 7. The frame memory 1 stores the input image signal Din for each frame. For example, the frame memory 1 stores a frame at time t. The frame at time t stored in the frame memory 1 is supplied to the frame memory 2, the motion estimation section 3, the motion allocation section 5, and the pixel generation section 7. The frame memory 2 stores the frame at time t+1, which is the next to the frame at time t. In this regard, in the following, the frame at time t, stored in the frame memory 1, is called a frame T, and the frame of the input image at time t+1, stored in the frame memory 2, is called a frame T+1.

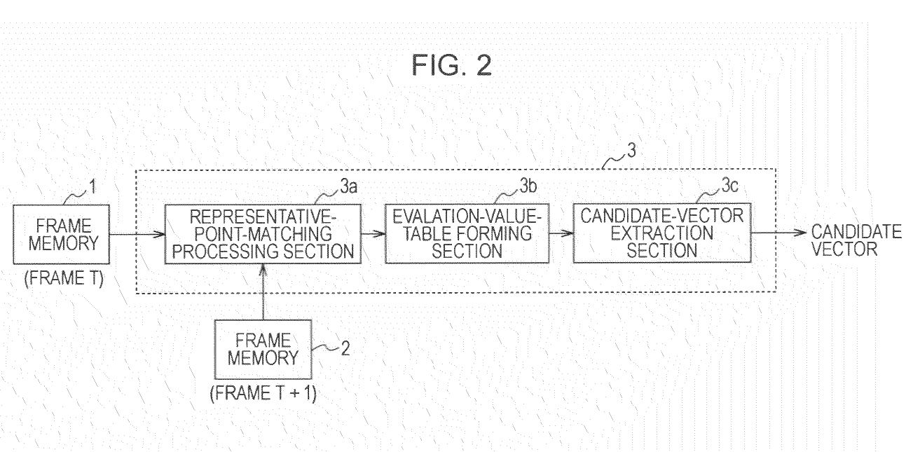

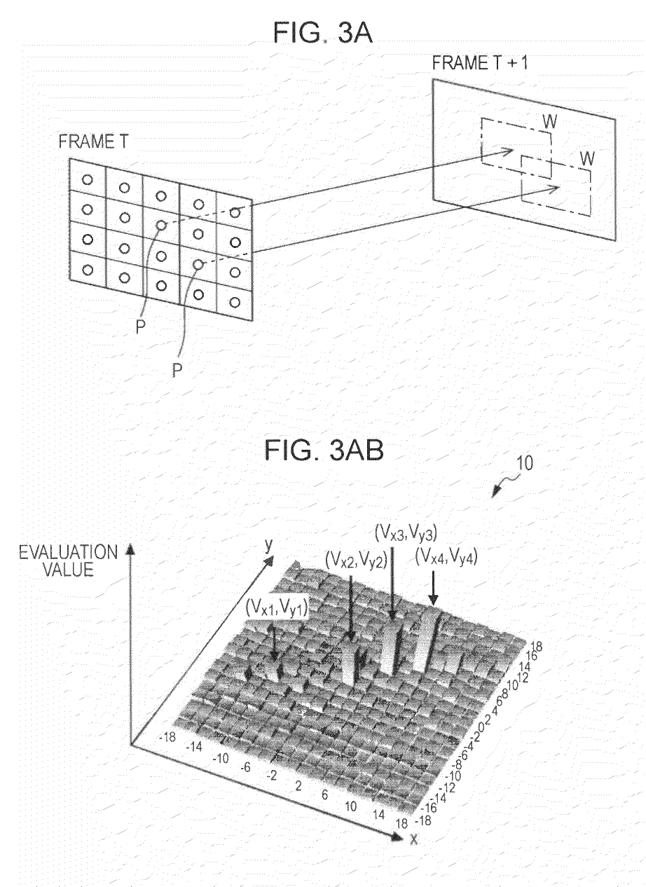

The motion estimation section 3 estimates a motion vector between the frames from the moving-mage frames T and T+1 input from the frame memories 1 and 2, for example, by a representative-point matching method or a block matching method. In this example, the motion estimation section 3 obtains a plurality of motion vectors to be candidates, and outputs the motion vector to the pixel generation section 4 as candidate vectors. In this regard, a detailed description will be given of the operation of the motion estimation section 3 with reference to FIGS. 2 and 3.

The pixel generation section 4 generates a predicted frame F corresponding to the existing frame T from the plurality of candidate vectors and the frames T−1 and T+1. For example, the pixel generation section 4 performs sum-of-product calculation on the taps of the frames T−1 and T+1, determined by the candidate vectors and the prediction coefficients stored in advance to generate a predicted pixel of a predicted frame F. The prediction coefficients for generating the predicted frame F have been generated for each class in advance by learning a relationship between a student image representing the predicted frame F and a teacher image representing the frame T of the input image signal Din, and is stored in a memory not shown in the figure.

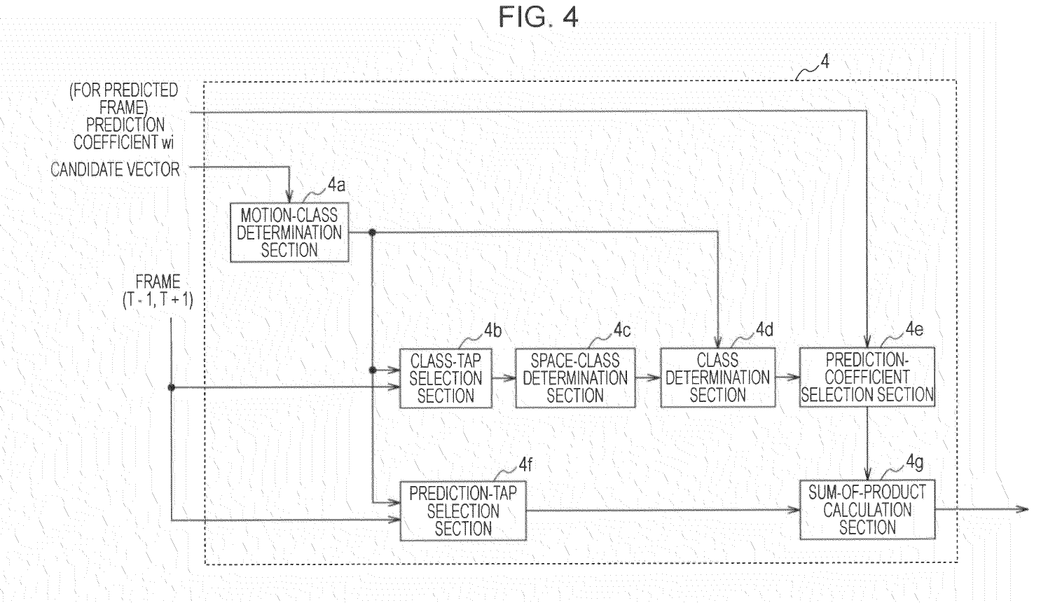

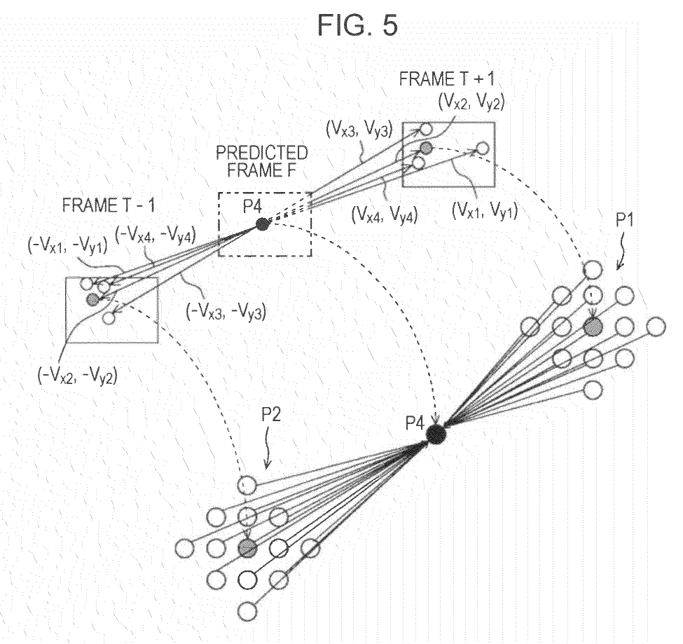

The pixel generation section 4 generates a predicted pixel of the predicted frame F for all the candidate vectors, and outputs the individual predicted pixels and the candidate vectors corresponding to the pixels to the motion allocation section 5. In this regard, a detailed description will be given of the operation of the pixel generation section 4 with reference to FIGS. 4 and 5.

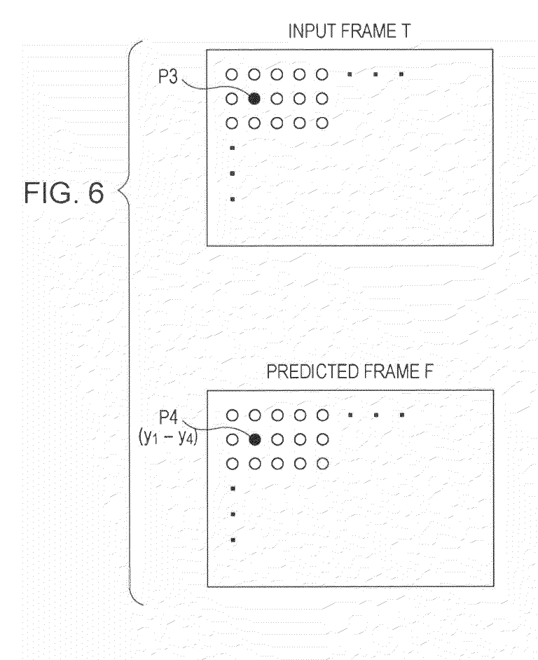

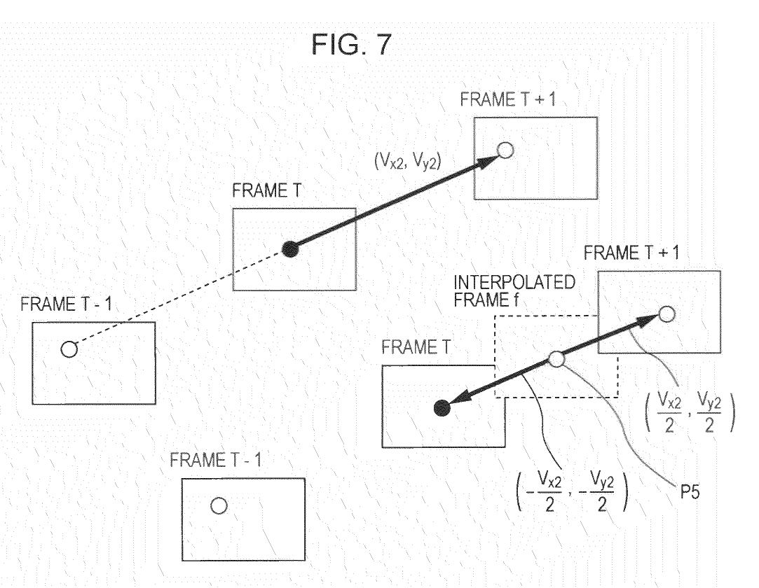

The motion allocation section 5 obtains an absolute difference values between the individual predicted pixels of the predicted frame F input from the pixel generation section 4 and the pixels of the existing frame T, respectively. The motion allocation section 5 selects a candidate vector in a predicted pixel having a minimum absolute difference. And the motion allocation section 5 allocates a candidate vector to each pixel of the newly generated interpolated frame located at the midpoint of the frame T and the frame T+1 to be an allocated vector. In this regard, a detailed description will be given of the operation of the motion allocation section 5 with reference to FIGS. 6 and 7.

The motion compensation section 6 searches and allocates a neighboring allocated vector to a pixel of the interpolated frame to which an allocated vector has not been allocated by the motion allocation section 5. Thus, all the pixels in the interpolated frame have allocated vectors.

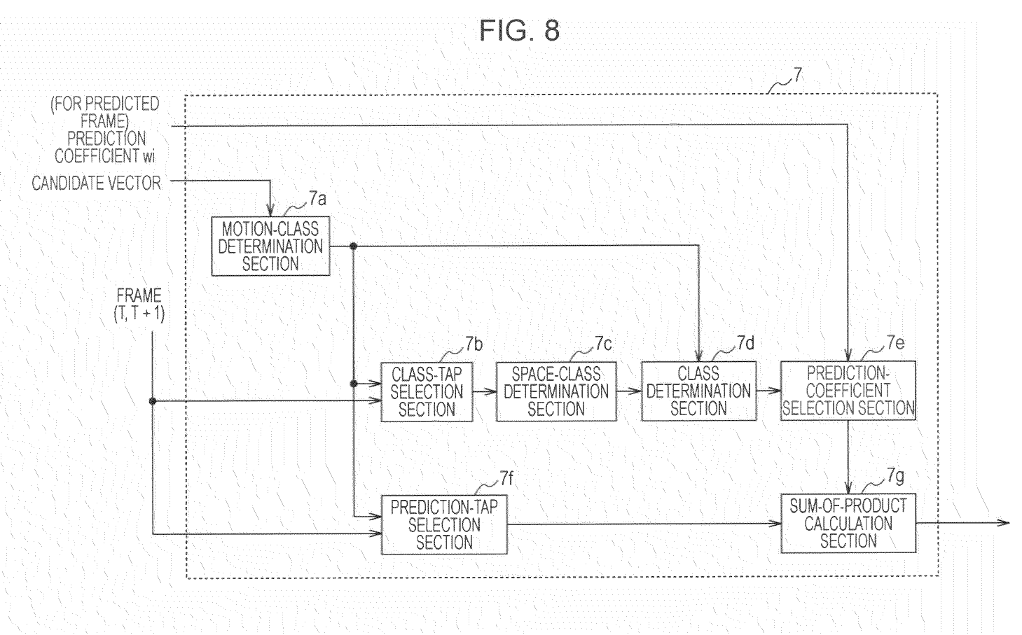

The pixel generation section 7 generates pixel values of the interpolated frame from the frames T, T+1, and the allocated vectors. The pixel generation section 7 performs sum-of-product calculation on the taps of the frames T and T+1, which are determined by the allocated vectors, and the prediction coefficients stored in advance to generate a pixel value of a pixel of the interpolated frame, and outputs the pixel value to the output terminal 9 as an output image signal Dout. The prediction coefficients for generating the interpolated frame have been generated for each class in advance by learning a relationship between a student image representing the input image signal Din having a low frequency and a teacher image representing an image signal having a high frequency, and is stored in a memory not shown in the figure. In this regard, a detailed description will be given of the operation of the pixel generation section 7 with reference to FIG. 8.

Next, a description will be given of an example of the operation of the motion estimation section 3 with reference to FIGS. 2 and 3. FIG. 2 is a block diagram illustrating an example of a configuration of the motion estimation section 3. The motion estimation section 3 shown in FIG. 2 includes a representative-point-matching processing section 3a, an evaluation-value-table forming section 3b, and a candidate-vector extraction section 3c.

The representative-point-matching processing section 3a inputs the frame T from the frame memory 1, and inputs the frame T+1 from the frame memory 2. The representative-point-matching processing section 3a determines a representative point of the frame T, which is determined in advance, or a selected representative point. For example, as shown in FIG. 3A, the frame T is divided into a plurality of blocks, and representative points representing individual blocks are set. The representative points P of the individual blocks correspond to pixel values representing blocks, for example, the pixel values of the central points of the blocks, the average values of the pixel values of all the pixels in the blocks, etc.

The representative-point-matching processing section 3a sets a predetermined search area W in the frame T+1 correspondingly to the representative point P of the block set in the frame T, and compares the pixel values of the individual pixels included in the set search area W and the pixel values of the representative points P. For example, the representative-point-matching processing section 3a obtains the absolute difference value between the pixel value of the representative point P and the pixel value of each pixel in the search area W, and the smaller the absolute difference is, that is to say, the higher the correlation is, the higher evaluation value is set. For example, “+1” is added to the evaluation value table 10. This evaluation value is calculated for each pixel in the search area W. In the same manner, search areas W are set in the frame T+1 correspondingly to individual representative points of the blocks set in the frame T. And the pixel values of the representative points P and the evaluation values of the pixel values of the individual pixels in the corresponding search areas W are obtained of be output to the evaluation-value-table forming section 3b. In this regard, a search area W corresponding to each representative point P may be set overlapped partly with an adjacent search area W as shown in FIG. 3A.

As shown in FIG. 3B, the evaluation-value-table forming section 3b accumulates the evaluation values on all the representative points P in one screen to form the evaluation value table 10 having the same size as the search area W. A peak (an extreme value) arises in the evaluation value table 10 shown in FIG. 3B when a correlation is high between the pixel value of each pixel position in the search area W and the pixel value of the representative point P. The peak corresponds to a movement of a display object in the screen of the moving image data.

For example, if the entire frame moves in the same manner, one peak corresponding to a motion vector having a same direction and distance appears in the evaluation value table 10. Also, if there are two objects that moves differently in a frame, two peaks corresponding to two vectors having different motion directions and distances appear in the evaluation value table 10.

Candidates of a motion vector (candidate vectors) in the frames T and T+1 are obtained on the basis of such peaks appearing in the evaluation value table 10. In this example, the candidate-vector extraction section 3c extracts four motion vectors (Vₓ₁, V_{y1}) to (Vₓ₄, V_{y4}) having high evaluation values as candidate vectors from the evaluation value table 10 shown in FIG. 3B, and outputs the motion vectors to the pixel generation section 4.

Next, a description will be given of an example of the operation of the pixel generation section 4 with reference to FIGS. 4 and 5. FIG. 4 is a block diagram illustrating an example of a configuration of the pixel generation section 4. The pixel generation section 4 shown in FIG. 4 includes a motion-class determination section 4a, a class-tap selection section 4b, a space-class determination section 4c, a class determination section 4d, a prediction-coefficient selection section 4e, a prediction-tap selection section 4f, and a sum-of-product calculation section 49.

The motion-class determination section 4a inputs the candidate vectors (Vₓ₁, V_{y1}) to (Vₓ₄, V_{y4}) obtained by the motion estimation section 3. The motion-class determination section 4a determines a motion class including a predicted pixel from the direction and the size of the candidate vectors (Vₓ₁, V_{y1}) to (Vₓ₄, V_{y4}). And the motion-class determination section 4a outputs the information indicating the determined motion class to the class-tap selection section 4b, the prediction-tap selection section 4f, and the class determination section 4d.

The class-tap selection section 4b selectively extracts a pixel at a predetermined position (called a class tap), to be used for grouping a space class, from the frames T−1 and T+1 by referring to the motion class, and outputs the extracted class-tap data to the space-class determination section 4c.

The space-class determination section 4c determines a space class by performing processing including ADRC (Adaptive Dynamic Range Coding), etc., on the basis of the class tap, and outputs the information indicating the determined space class to the class determination section 4d.

The class determination section 4d determines a final class on the basis of the information indicating the space class supplied from the space-class determination section 4c and the information indicating the motion class supplied from the above-described motion-class determination section 4a. The class determination section 4d outputs the information indicating the determined final class to the prediction-coefficient selection section 4e.

The prediction-coefficient selection section 4e selects prediction coefficients for the predicted frame corresponding to the final class from the class determination section 4d, and outputs the prediction coefficients to the sum-of-product calculation section 4g. In this regard, the prediction-coefficient selection section 4e selects the prediction coefficients by referring to the coefficient memory, not shown in the figure, storing the prediction coefficients corresponding to a class, which have been determined in advance as described later.

At the same time, the prediction-tap selection section 4f refers to the motion class supplied from the motion-class determination section 4a, and selectively extracts a predetermined pixel area (called a prediction tap) from the frames T−1 and T+1. For example, as shown in FIG. 5, the prediction-tap selection section 4f extracts a prediction tap P1 including 13 pixels from the frame T+1, extracts a prediction tap P2 including 13 pixels from the frame T−1, and outputs the extracted prediction taps P1 and P2 to the sum-of-product calculation section 49. In this regard, FIG. 5 is a schematic diagram illustrating an example of generation of a pixel. In FIG. 5, candidate vectors (Vₓ₁, V_{y1}) to (Vₓ₄, V_{y4}) passing through the predicted pixel P4 are shown.

The sum-of-product calculation section 4g performs sum-of-product calculation in accordance with the following Expression (1) on the basis of the pixel value xi of the prediction taps P1 and P2 and the prediction coefficients wi supplied from the prediction-coefficient selection section 4e to generate a pixel value y of a predicted pixel P4 of a predicted frame F.

y=w1×x1+w2×x2+ . . . +wn×xn (1)

where x1, . . . , xn are pixel values of individual prediction taps, and w1, . . . , wn are individual prediction coefficients.

The sum-of-product calculation section 4g generates pixel values y₁ to y₄ of the predicted pixels of the predicted frame F for all the candidate vectors (Vₓ₁, V_{y1}) to (Vₓ₄, V_{y4}). And the sum-of-product calculation section 4g outputs the individual pixel values y₁ to y₄ and the corresponding candidate vectors (Vₓ₁, V_{y1}) to (Vₓ₄, V_{y4}) to the motion allocation section 5.

The motion allocation section 5 obtains the absolute difference values between the pixel values y₁ to y₄ of the predicted pixels of the predicted frame F input from the pixel generation section 4 and the pixel values of the pixels of the existing frame T. For example, as shown in FIG. 6, the motion allocation section 5 obtains the absolute difference value between the pixel value y₁ of the predicted pixel P4 of the predicted frame F and the pixel value of the pixel P3 of the frame T having the same position as the predicted pixel P4. In the same manner, the motion allocation section 5 obtains the absolute difference values between the pixel values y₂ to y₄ of the predicted pixel P4 of the predicted frame F and the pixel value of the pixel P3 having the same position as the predicted pixel P4. The motion allocation section 5 selects a candidate vector related to the pixel value of the predicted pixel P4 having a minimum absolute difference. That is to say, the motion allocation section 5 performs matching.

For example, if the absolute difference value of the pixel value y₂ is a minimum, as shown in FIG. 7, the motion allocation section 5 selects a candidate vector (Vₓ₂, V_{y2}) related to the pixel value y₂. The motion allocation section 5 allocates the selected candidate vector (Vₓ₂, V_{y2}) to the pixel P5 of the interpolated frame f. For example, if the interpolated frame f is located at the midpoint of the frames T and T+1, the allocated vectors (Vₓ₂/2, V_{y2}/2) and (−Vₓ₂/2, −V_{y2}/2) are allocated to the pixel P5 of the interpolated frame f as shown in FIG. 7.

The motion compensation section 6 searches and allocates a neighboring allocated vector to a pixel of the interpolated frame to which an allocated vector has not been allocated unlike the above-described pixel P5.

For example, the pixel generation section 7 generates the pixel value of the pixel P5 of the interpolated frame f from the frames T and T+1, and the allocated vectors (Vₓ₂/2, V_{y2}/2) and (−Vₓ₂/2, −V_{y2}/2). The pixel generation section 7 performs sum-of-product calculation on the taps of the frames T and T+1, which are determined by the allocated vectors (Vₓ₂/2, V_{y2}/2) and (−Vₓ₂/2, −V_{y2}/2), and the prediction coefficients stored in advance to generate the pixel value of the pixel P5 of the interpolated frame f.

For example, FIG. 8 is a block diagram illustrating an example of a configuration of the pixel generation section 7. The pixel generation section 7 shown in FIG. 8 has a substantially same configuration as that of the pixel generation section 4 shown in FIG. 4, and thus the detailed description thereof will be omitted. The pixel generation section 7 shown in FIG. 8 includes a motion-class determination section 7a, a class-tap selection section 7b, a space-class determination section 7c, a class determination section 7d, a prediction-coefficient selection section 7e, a prediction-tap selection section 7f, and a sum-of-product calculation section 79.

The motion-class determination section 7a inputs the allocated vector by the motion allocation section 5 and the motion compensation section 6. The motion-class determination section 7a determines a motion class including a pixel of an interpolated frame f from the direction and the size of the allocated vectors. And the motion-class determination section 7a outputs the information indicating the determined motion class to the class-tap selection section 7b, the prediction-tap selection section 7f, and the class determination section 7d.

The class-tap selection section 7b selectively extracts a class tap to be used for grouping a space class from the frames T and T+1 by referring to the motion class, and outputs the extracted class-tap data to the space-class determination section 7c.

The space-class determination section 7c determines a space class by performing processing including ADRC, etc., on the basis of the class tap, and outputs the information indicating the determined space class to the class determination section 7d.

The class determination section 7d determines a final class on the basis of the information indicating the space class supplied from the space-class determination section 7c and the information indicating the motion class supplied from the above-described motion-class determination section 7a. The class determination section 7d outputs the information indicating the determined final class to the prediction-coefficient selection section 7e.

The prediction-coefficient selection section 7e selects prediction coefficients for the interpolated frame corresponding to the final class from the class determination section 7d, and outputs the prediction coefficients to the sum-of-product calculation section 7g. In this regard, the prediction-coefficient selection section 7e selects the prediction coefficients by referring to the coefficient memory, not shown in the figure, storing the prediction coefficients corresponding to a class, which have been determined in advance as described later.

At the same time, the prediction-tap selection section 7f refers to the motion class supplied from the motion-class determination section 7a, and selectively extracts a prediction tap from the frames T and T+1.

The sum-of-product calculation section 7g performs sum-of-product calculation in accordance with the above-described Expression (1) on the basis of the prediction taps extracted by the prediction-tap selection section 7f and the prediction coefficients supplied from the prediction-coefficient selection section 7e to generate a pixel value y of an interpolated frame f. The sum-of-product calculation section 79 generates the pixel values of all the pixels in the interpolated frame f on the basis of the allocated vectors.

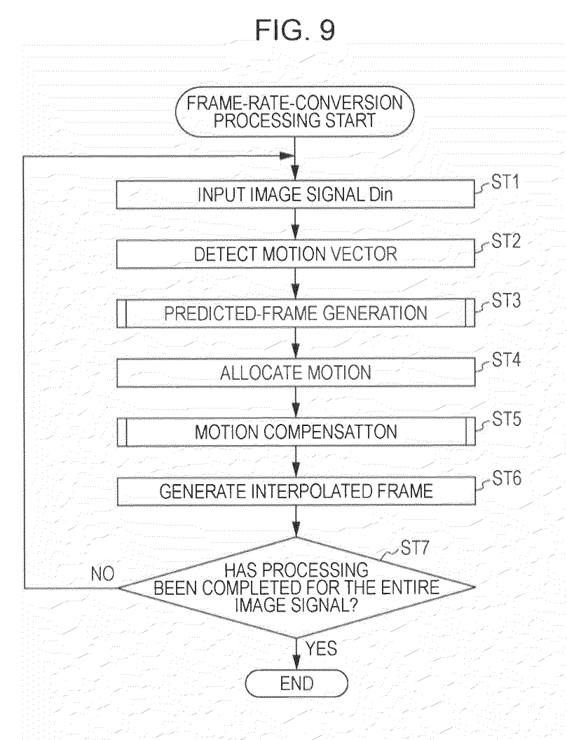

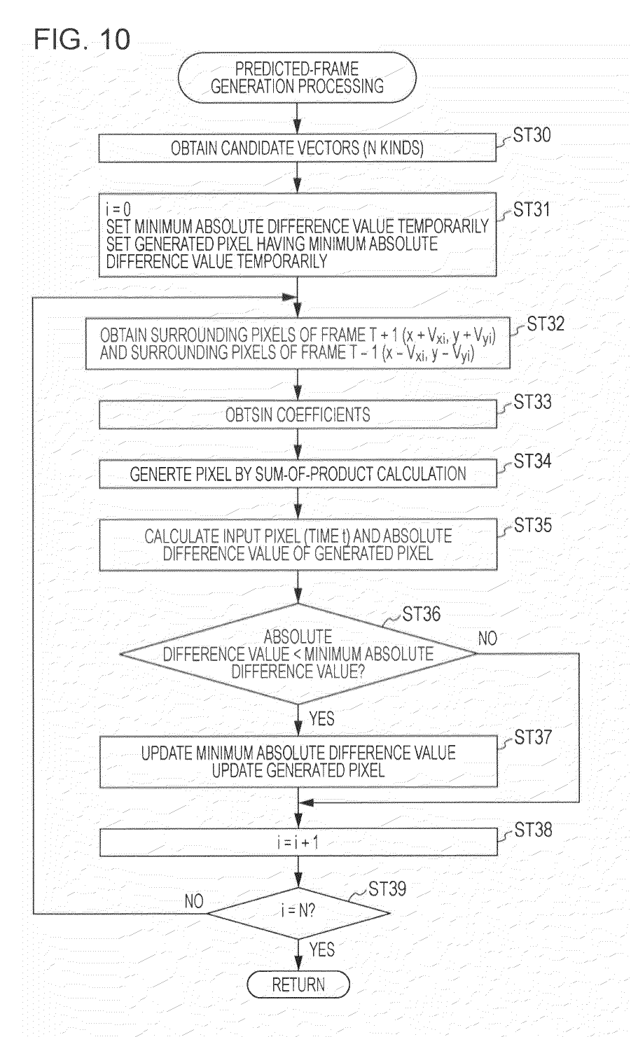

Next, a description will be given of an example of an operation of the frame-frequency conversion apparatus 100 with reference to FIGS. 9 and 10. FIG. 9 is a flowchart illustrating an example of the operation of the frame-frequency conversion apparatus 100. In step ST1 shown in FIG. 9, the frame-frequency conversion apparatus 100 shown in FIG. 1 stores the frame T of the input image signal Din at time t into the frame memory 1, and stores the frame T+1 at the next time t+1 into the frame memory 2. The frames T and T+1 stored in the frame memories 1 and 2, respectively, are output to the motion estimation section 3. Next, the processing proceeds to step ST2.

In step ST2, the motion estimation section 3 obtains a motion vector to be a candidate between the frames by the representative-point matching method on the basis of the frames T and T+1 input from the frame memories 1 and 2. For example, as shown in FIGS. 2, 3A, and 3B, the motion estimation section 3 obtains the pixel value of the representative point P and the evaluation value of the pixel value of the corresponding individual pixel in the search area W. And the motion estimation section 3 accumulates the evaluation values for all the representative points P in one screen, and forms the evaluation value table 10 having the same size as that of the search area W. The motion estimation section 3 obtains candidate vectors in the frames T and T+1 on the basis of the peaks that appears in the evaluation value table 10. Next, the processing proceeds to step ST3.

In step ST3, the pixel generation section 4 generates a predicted frame F. FIG. 10 is a flowchart illustrating the generation processing of the predicted frame F. In step ST30 shown in FIG. 10, the pixel generation section 4 obtains a plurality of candidate vectors (Vₓ₁, V_{y1}) to (Vₓ₄, V_{y4}) shown in FIG. 3B, and the processing proceeds to step ST31.

In step ST31, the pixel generation section 4 initializes a minimum absolute difference value. For example, the pixel generation section 4 temporarily sets the minimum absolute difference value and the pixel value of the pixel thereof. Also, a counter [i] counting the number of candidate vectors is set to zero. Next, the processing proceeds to step ST32.

In step ST32, as shown in FIG. 5, the pixel generation section 4 obtains the prediction taps P1 and P2 from the frames T+1, T−1 determined by the candidate vectors, and the processing proceeds to step ST33.

In step ST33, the pixel generation section 4 obtains the prediction coefficients. For example, as shown in FIG. 4, the pixel generation section 4 obtains the prediction coefficients corresponding to the class from the prediction coefficients stored in advance in the coefficient memory, not shown in the figure, used for the class grouping adaptation processing, and the processing proceeds to step ST34.

In step ST34, the pixel generation section 4 performs sum-of-product calculation on the prediction coefficients and the prediction taps P1 and P2 by the above-described expression (1) to generate the pixel value of the predicted pixel of the predicted frame F, and the processing proceeds to step ST35.

In step ST35, the motion allocation section 5 calculates the absolute difference value between the pixel value of the predicted pixel of the predicted frame F input from the pixel generation section 4 and the pixel value of the pixel of the existing frame T. For example, as shown in FIG. 6, the motion allocation section 5 obtains the absolute difference value between the pixel value y₁ of the predicted pixel P4 of the predicted frame F and the pixel value of the pixel P3 having the same position as the predicted pixel P4, and the processing proceeds to step ST36.

In step ST36, the motion allocation section 5 compares the absolute difference obtained in step ST35 and the minimum absolute difference set in step ST31 described above. If the absolute difference obtained in step ST35 is less than the minimum absolute difference value, the processing proceeds to step ST37. Also, if the absolute difference obtained in step ST35 is not less than the minimum absolute difference value, the processing proceeds to step ST38.

In step ST37, the motion allocation section 5 updates the minimum absolute difference value to the absolute difference value obtained in step ST35, and also updates the pixel value of the predicted pixel P4 to the pixel value y₁, and the processing proceeds to step ST38.

In step ST38, the motion allocation section 5 increments the counter “i” counting the number o the candidate vectors, and the processing proceeds to step ST39. In step ST39, the motion allocation section 5 determines whether the number of candidate vectors has reached an upper limit by comparing the counter “i” and the number of the candidate vectors “IN”. If the number of candidate vectors has not reached the upper limit, the processing returns to step ST32. If the number of candidate vectors has reached the upper limit, the processing proceeds to step ST4 in the flowchart in FIG. 9. In this manner, the pixel value of the predicted pixel of the predicted frame F and the candidate vector thereof are selected.

In step ST4 in FIG. 9, the motion allocation section 5 allocates a candidate vector to each pixel of the interpolated frame f positioned at the midpoint of the frames T and T+1 to be an allocated vector. For example, as shown in FIG. 7, if the absolute difference value of the pixel value y₂ is a minimum, the motion allocation section 5 allocates the candidate vector (Vₓ₂, V_{y2}) thereof to the pixel P5 of the interpolated frame f. In this example, if the interpolated frame f is located at the midpoint of the frames T and T+1, the allocated vectors (Vₓ₂/2, V_{y2}/2) and (−Vₓ₂/2, −V_{y2}/2) are allocated to the pixel P5 of the interpolated frame f as shown in FIG. 7. Next, the processing proceeds to step ST5.

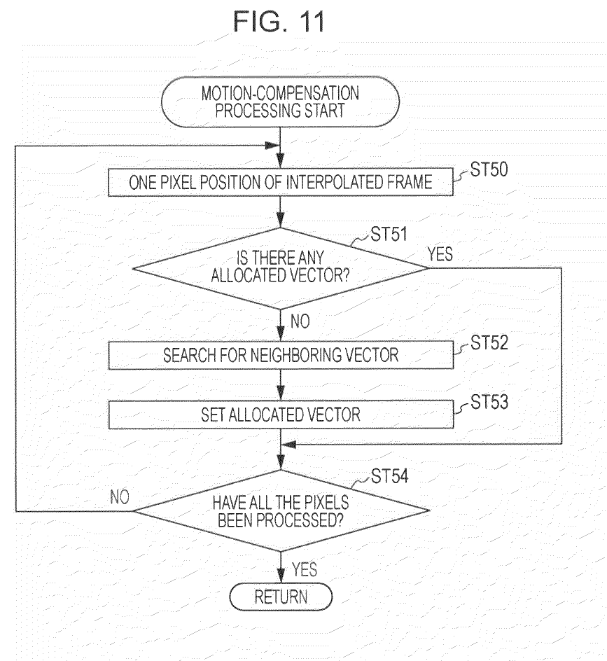

In step ST5, the motion compensation section 6 searches for an allocated vector, and allocates to a pixel of the interpolated frame f to which an allocated vector has not been allocated by the motion allocation section 5. FIG. 11 is a flowchart illustrating the motion compensation processing. In step ST50 shown in FIG. 11, the motion compensation section 6 selects the pixel in the interpolated frame f from the upper left pixel in the interpolated frame f for each pixel in the raster scanning sequence. Next, the processing proceeds to step ST51.

In step ST51, the motion compensation section 6 determines whether there is a vector allocated to the selected pixel. If there is an allocated vector, the processing proceeds to step ST54. If there is not an allocated vector, the processing proceeds to steps ST52 and ST53.

In steps ST52 and ST53, the motion compensation section 6 searches for an allocated vector to a neighboring pixel. The motion compensation section 6 allocates the searched allocated vector to the pixel to which a vector has not been allocated. In this case, one allocated vector may be directly allocated, or an average of a plurality of allocated vectors may be allocated. Next, the processing proceeds to step ST54.

In steps ST54, the motion compensation section 6 determines whether the processing for all the pixels in the interpolated frame f. If the processing for all the pixels in the interpolated frame f has not been completed, the processing returns to step ST50. If the processing for all the pixels in the interpolated frame f has been completed, the processing proceeds to step ST6 of the flowchart in FIG. 9.

In step ST6 of the flowchart in FIG. 9, the pixel generation section 7 generates the interpolated frame f. For example, as shown in FIG. 7, the pixel generation section 7 generates the pixel value of the pixel P5 of the interpolated frame f from the frames T and T+1, and the allocated vectors (Vₓ₂/2, V_{y2}/2) and (−Vₓ₂/2, −V_{y2}/2). The pixel generation section 7 performs sum-of-product calculation on the taps of the frames T and T+1, which are determined by the allocated vectors (Vₓ₂/2, V_{y2}/2) and (−Vₓ₂/2, −V_{y2}/2), and the prediction coefficients stored in advance to generate the pixel value of the pixel P5 of the interpolated frame f. In the same manner, the pixel generation section 7 generates the pixel values of all the pixels in the interpolated frame f, and the processing proceeds to step ST7.

In steps ST7, the frame-frequency conversion apparatus 100 determines whether the processing has been completed for the entire input image signal Din. If the processing has not been completed for the entire input image signal Din, the processing returns to step ST1. If the processing has been completed for the entire input image signal Din, the frame-rate conversion processing is terminated.

In this manner, by the present invention, the predicted pixel of the predicted frame F corresponding to an existing frame is generated from the pixel determined by a candidate vector. Then, correlations between individual predicted pixels of the generated predicted frame F and the pixels of the existing frame T are obtained, and a candidate vector of the predicted pixel having a high correlation is selected.

Accordingly, it is possible to select an optimum candidate vector from a plurality of candidate vectors. Furthermore, a correlation is obtained for each pixel, and thus compared with a method of obtaining a correlation for each block, it becomes possible to correctly detect a motion vector on a boundary of an object in an image.

In this regard, the pixel generation sections 4 and 7 generates pixels using class-grouping adaptation processing. However, the method of generating pixels is not limited to this. For example, a pixel indicated by the end point of a vector may be directly used. Alternatively, a pixel may be generated by averaging the individual pixels indicated by a vector and the inverse vector thereof.

### Second Embodiment

### Generation of Prediction Coefficients

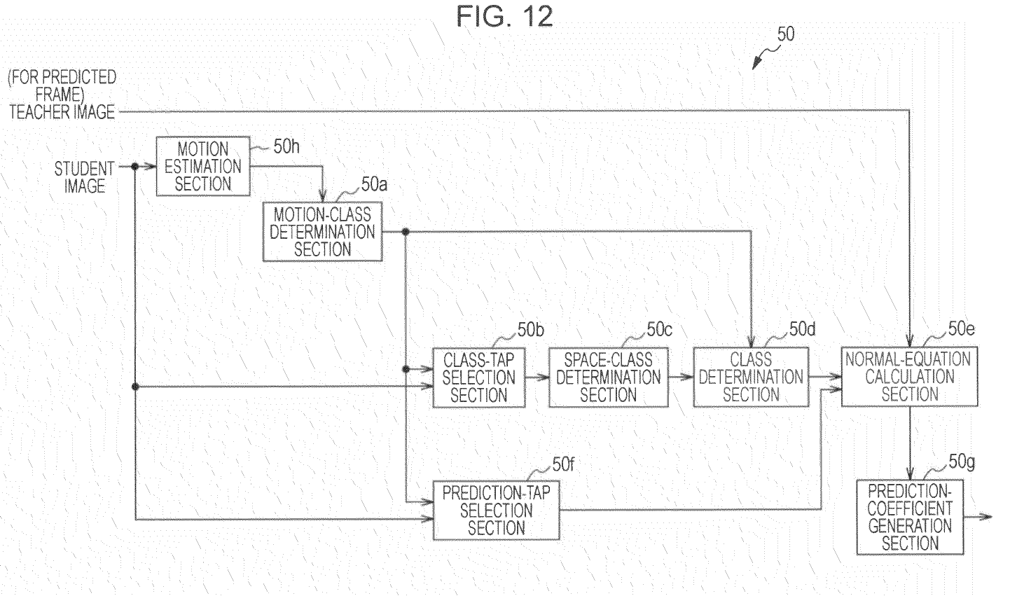

Next, a description will be given of a method of calculating the prediction coefficients to be used for generating a predicted frame F. FIG. 12 is a block diagram illustrating an example of a configuration of a prediction-coefficient generation apparatus 50. The prediction-coefficient generation apparatus 50 shown in FIG. 12 includes a motion estimation section 50h, a motion-class determination section 50a, a class-tap selection section 50b, a space-class determination section 50c, a class determination section 50d, a normal-equation calculation section 50e, a prediction-coefficient generation section 509, and a prediction-tap selection section 50f.

The motion estimation section 50h obtains a motion vector, for example by a representative-point matching method on the basis of a student image corresponding to the frames T and T+1, and outputs the motion vector to the motion-class determination section 50a.

The motion-class determination section 50a inputs the motion vector obtained by the motion estimation section 50h. The motion-class determination section 50a determines a motion class including a predicted pixel of the predicted frame F from the direction and the size of the motion vector. And the motion-class determination section 50a outputs the information indicating the determined motion class to the class-tap selection section 50b, the prediction-tap selection section 50f, and the class determination section 50d.

The class-tap selection section 50b selectively extracts a class tap to be used for grouping into space class from the frames T−1 and T+1 with reference to the motion class, and outputs the extracted class tap data to the space-class determination section 50c.

The space-class determination section 50c determines a space class by performing processing including ADRC, etc., on the basis of the class tap, and outputs the information indicating the determined space class to the class determination section 50d.

The class determination section 50d determines a final class on the basis of the information indicating the space class supplied from the space-class determination section 50c and the information indicating the motion class supplied from the above-described motion-class determination section 50a. The class determination section 50d outputs the information indicating the determined final class to the normal-equation calculation section 50e.

The prediction-tap selection section 50f refers to the motion class supplied from the motion-class determination section 50a, selectively extracts prediction taps from the frames T−1 and T+1, and outputs the prediction taps to the normal-equation calculation section 50e.

The normal-equation calculation section 50e generates a normal equation data, and outputs the data to the prediction-coefficient generation section 50g. The prediction-coefficient generation section 50g performs calculation processing using the normal equation data to generate prediction coefficients.

In the following, a description will be given of the calculation of the prediction coefficients in the case of a more generalized prediction by n pixels. Assuming that the luminance levels of input pixels selected by prediction tap are x1, x2, . . . , xn, and the output luminance level is E|y|, a linear estimate equation having n taps is set to the prediction coefficients w₁, w₂, . . . , wₙ for each class. This is expressed by the following Expression (2).

[Formula 1]

E[y]=w₁x₁+w₂x₂+ . . . +wᵢxᵢ (2)

As a method of obtaining the prediction coefficients w₁, w₂, . . . , wₙ in Expression (2), a solution by the least-squares method is considered to be used. In this solution, assuming that X is the luminance level of the input pixel, W is the prediction coefficient, and Y′ is the luminance level of the output pixel, data is collected so that the observation equation of Expression (3) is formed. In Expression (3), m represents the number of learning data, and n represents the number of prediction taps as described above.

$$\begin{matrix}[ Formula 2 ] & \\ X = [ \begin{matrix}{X}_{11} & {X}_{12} & … & {X}_{1 n} \\ {X}_{21} & {X}_{22} & … & {X}_{2 n} \\ … & … & … & … \\ {x}_{m 1} & {x}_{m 2} & … & {x}_{mn}\end{matrix} ] \\ W = [ \begin{matrix}{W}_{1} \\ {W}_{2} \\ … \\ {W}_{m}\end{matrix} ] , {Y}^{′} = [ \begin{matrix}E [ {y}_{1} ] \\ E [ {y}_{2} ] \\ … \\ E [ {y}_{m} ]\end{matrix} ] \\ XW = {Y}^{′} & ( 3 )\end{matrix}$$

Next, a residual equation of Expression (4) is set up on the basis of the observation equation of Expression (3).

$$\begin{matrix}[ Formula 3 ] & \\ E = [ \begin{matrix}{e}_{1} \\ {e}_{2} \\ … \\ {e}_{m}\end{matrix} ] , Y = [ \begin{matrix}{y}_{1} \\ {y}_{2} \\ … \\ {y}_{m}\end{matrix} ] \\ XW = Y + E & ( 4 )\end{matrix}$$

From Expression (4), a most probable value of each of the prediction coefficient wi is obtained in the case where the condition for minimizing Expression (5) is satisfied.

$$\begin{matrix}[ Formula 4 ] & \\ {\sum }_{i = 1}^{m} {e}_{i}^{2} & ( 5 )\end{matrix}$$

That is to say, the condition of Expression (6) ought to be considered.

$$\begin{matrix}[ Formula 5 ] & \\ {e}_{1} \frac{\partial {e}_{1}}{\partial {w}_{i}} + {e}_{2} \frac{\partial {e}_{2}}{\partial {w}_{i}} + … + {e}_{m} \frac{\partial {e}_{m}}{\partial {w}_{i}} = 0 \\ ( i = 1 , 2 , … , n ) & ( 6 )\end{matrix}$$

In consideration of n conditions based on i in Expression (6), w₁, w₂, . . . , wn satisfying the conditions ought to be calculated. Thus, it is assumed that the following Expression (7) is obtained from Expression (4), and further, Expression (8) is obtained from Expressions (6) and (7).

$$\begin{matrix}[ Formula 6 ) & \\ \frac{\partial {e}_{i}}{\partial {w}_{i}} = {x}_{i 1} , \frac{\partial {e}_{i}}{\partial {w}_{i}} = {x}_{i 2} , … , \frac{\partial {e}_{i}}{\partial {w}_{n}} = {x}_{in} \\ ( i = 1 , 2 , … , m ) & ( 7 ) \\ {\sum }_{i = 1}^{m} {e}_{i} {x}_{i 1} = 0 , {\sum }_{i = 1}^{m} {e}_{i} {x}_{i 2} = 0 , … , {\sum }_{i = 1}^{m} {e}_{i} {x}_{in} = 0 & ( 8 )\end{matrix}$$

From Expressions (4) and (8), the following normal equation of Expression (9) can be obtained.

$$\begin{matrix}[ Formula 7 ] & \\ ( {\sum }_{i = 1}^{m} {x}_{i 1} {x}_{i 1} ) {w}_{1} + {\sum }_{i = 1}^{m} {x}_{i 1} {x}_{i 2} ) {w}_{2} + … + {\sum }_{i = 1}^{m} {x}_{i 1} {x}_{in} ) {w}_{n} = ( {\sum }_{i = 1}^{m} {x}_{i 1} {y}_{i} ) & ( 9 ) \\ ( {\sum }_{i = 1}^{m} {x}_{i 2} {x}_{i 1} ) {w}_{1} + {\sum }_{i = 1}^{m} {x}_{i 2} {x}_{i 2} ) {w}_{2} + … + {\sum }_{i = 1}^{m} {x}_{i 2} {x}_{in} ) {w}_{n} = ( {\sum }_{i = 1}^{m} {x}_{i 2} {y}_{i} ) & \\ … & \\ ( {\sum }_{i = 1}^{m} {x}_{in} {x}_{i 1} ) {w}_{1} + {\sum }_{i = 1}^{m} {x}_{in} {x}_{i 2} ) {w}_{2} + … + {\sum }_{i = 1}^{m} {x}_{in} {x}_{in} ) {w}_{n} = ( {\sum }_{i = 1}^{m} {x}_{in} {y}_{i} ) & \end{matrix}$$

The normal equations of Expression (9) are simultaneous equations having n unknown quantities, and thus most probable values of the individual wᵢ can be obtained by the equations. In practice, the simultaneous equations are solved using a sweep-out method (Gauss-Jordan elimination).

The normal equations of Expression (9) are solved to determine the prediction coefficients w₁, w₂, . . . , wₙ. As a result of the learning as described above, the prediction coefficients of the predicted frame F allowing a nearest estimation to a true value statistically are calculated in order to estimate the luminance level of a pixel of interest for each class.

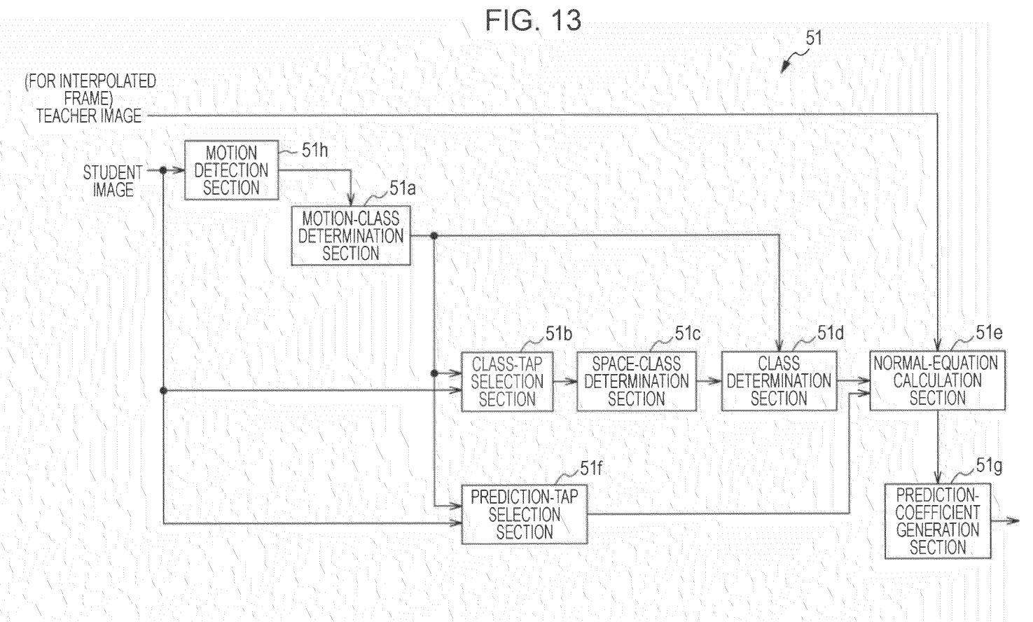

Next, a description will be given of a method of calculating the prediction coefficients to be used for generating the interpolated frame f. FIG. 13 is a block diagram illustrating an example of a configuration of a prediction-coefficient generation apparatus 51. The prediction-coefficient generation apparatus 51 shown in FIG. 13 has a substantially same configuration as that of the prediction-coefficient generation apparatus 50 shown in FIG. 12, and thus the detailed description thereof will be omitted.

The prediction-coefficient generation apparatus 51 shown in FIG. 13 includes a motion detection section 51h, a motion-class determination section 51a, a class-tap selection section 51b, a space-class determination section 51c, a class determination section 51d, a normal-equation calculation section 51e, a prediction-tap selection section 51f, and a prediction-coefficient generation section 51g.

The motion detection section 51h obtains a motion vector of each pixel of the interpolated frame f on the basis of a student image corresponding to the frames T and T+1, and outputs the motion vector to the motion-class determination section 51a. In this regard, the motion detection section 51h includes, for example, the motion estimation section 3, the pixel generation section 4, the motion allocation section 5, and the motion compensation section 6, which are shown in FIG. 1.

The motion-class determination section 51a determines a motion class including a pixel of the interpolated frame f from the direction and the size of the motion vector obtained by the by the motion estimation section 51h. And the motion-class determination section 51a outputs the information indicating the determined motion class to the class-tap selection section 51b, the prediction-tap selection section 51f, and the class determination section 51d.

The class-tap selection section 51b selectively extracts a class tap to be used for grouping into space class from the frames T and T+1 with reference to the motion class, and outputs the extracted class tap data to the space-class determination section 51c.

The space-class determination section 51c determines a space class by performing processing including ADRC, etc., on the basis of the class tap, and outputs the information indicating the determined space class to the class determination section 51d.

The class determination section 51d determines a final class on the basis of the information indicating the space class supplied from the space-class determination section 51c and the information indicating the motion class supplied from the above-described motion-class determination section 51a. The class determination section 51d outputs the information indicating the determined final class to the normal-equation calculation section 51e.

The prediction-tap selection section 51f refers to the motion class supplied from the motion-class determination section 51a, selectively extracts prediction taps from the frames T and T+1, and outputs the prediction taps to the normal-equation calculation section 51e.

The normal-equation calculation section 51e generates a normal equation data, and outputs the data to the prediction-coefficient generation section 51g. The prediction-coefficient generation section 51g performs calculation processing using the normal equation data to generate prediction coefficients for the interpolated frame f. In this regard, in the case of a more generalized prediction by n pixels, the prediction coefficients are calculated in the same manner as the above-described Expressions (2) to (9), and thus the description thereof will be omitted.

Also, the above-described series of processing can be executed by hardware or by software. When the series of processing is executed by software, programs constituting the software may be installed in a computer built in a dedicated hardware. Alternatively, the various programs may be installed. For example, the programs may be installed in a general-purpose personal computer, etc., capable of executing various functions from a program recording medium.

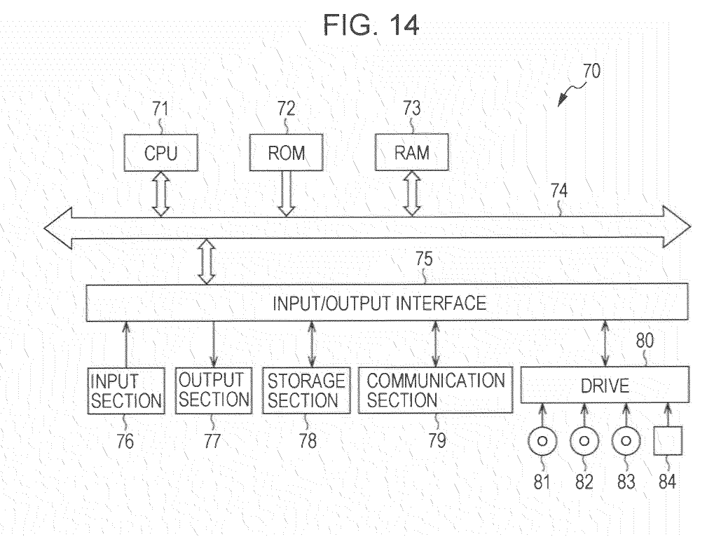

For example, FIG. 14 is a block diagram illustrating an example of a configuration of a computer 70 to which the present invention is applied. A CPU (Central Processing Unit) 71 of the computer 70 performs various kinds of processing in accordance with the programs stored in a ROM (Read Only Memory) 72 or a storage section 78. A RAM (Random Access Memory) 73 suitably stores the programs executed by the CPU 71, data, etc. The CPU 71, the ROM 72, and the RAM 73 are mutually connected through a bus 74.

The CPU 71 is connected to an input/output interface 75 through the bus 74. An input section 76 including a keyboard, a mouse, a microphone, etc., and an output section 77 including a display, a speaker, etc., are connected to the input/output interface 75. The CPU 71 executes various kinds of processing in accordance with instructions input from the input section 76. The CPU 71 outputs the images and sound, etc., obtained as a result of the processing to the output section 77.

The storage section 78 connected to the input/output interface 75 includes, for example, a hard disk, etc., and stores the programs executed by the CPU 71 and various kinds of data. A communication section 79 communicates with external apparatuses through a network such as the Internet, and the other networks. Also, the programs may be obtained through the communication section 79 to be stored in the storage section 78.

When a magnetic disk 81, an optical disc 82, a magneto-optical disc 83, or a semiconductor memory 84, etc., are attached to a drive 80, which is connected to the input/output interface 75, the drive 80 drives the above-described medium and obtains the programs, the data, etc., recorded there. The obtained programs and data are transferred to the storage section 78 as necessary, and are stored there. In this manner, the series of processing may be performed by the software on the computer 70.

The present application contains subject matter related to that disclosed in Japanese Priority Patent Application JP 2008-255108 filed in the Japan Patent Office on Sep. 30, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A frame-frequency conversion apparatus comprising:
a motion-estimation section inputting a first frame and a second frame of an image signal having a low frequency and estimating a plurality of candidate vectors indicating motions between the first frame and the second frame;
a first-pixel generation section generating a predicted pixel of a predicted frame corresponding to the second frame for each of the candidate vectors from a pixel determined by the candidate vector estimated by the motion estimation section;
a motion allocation section obtaining a correlation between the individual predicted pixel of the predicted frame and a pixel of the second frame, selecting a candidate vector of a predicted pixel having a high value in the correlation, and allocating the selected candidate vector to an individual pixel of an interpolated frame interpolating the first frame and the second frame to determine the vector to be an allocated vector;
a motion compensation section allocating a neighboring allocated vector to a pixel of the interpolated frame to which the allocated vector has not been allocated by the motion allocation section; and
a second-pixel generation section generating a pixel of the interpolated frame from a pixel determined by the allocated vector and outputting an image signal having a high frequency.

2. The frame-frequency conversion apparatus according to claim 1,
wherein the first-pixel generation section includes:
a first-motion-class determination section determining a motion class including the predicted pixel from the candidate vector;
a first-prediction-coefficient selection section selecting a prediction coefficient having been obtained in advance for each motion class determined by the first-motion-class determination section and minimizing an error between a student image corresponding to the predicted frame and a teacher image corresponding to the second frame;
a first-prediction-tap selection section selecting a plurality of pixels located in the surroundings of the predicted pixel of the predicted frame at least from the first frame; and
a first calculation section calculating a prediction coefficient selected by the first-prediction-coefficient selection section and the plurality of pixels selected by the first-prediction-tap selection section to generate a predicted pixel of the predicted frame.

3. The frame-frequency conversion apparatus according to claim 2,
wherein the motion-estimation section includes:
a representative-point matching processing section determining a representative point in one of the first frame and the second frame, setting a search area corresponding to the representative point in the other of the first frame and the second frame, obtaining a correlation between a pixel value of each pixel included in the search area and a pixel value of the representative point, and setting an evaluation value in an evaluation value table;
an evaluation-value-table forming section integrating the evaluation values set by the representative-point matching processing section for all the representative points to form the evaluation value table; and
a candidate-vector extraction section extracting a motion quantity having a high evaluation value as a candidate vector from the evaluation value table.

4. The frame-frequency conversion apparatus according to claim 3,
wherein the second pixel generation section includes:
a second motion-class determination section determining a motion class including a pixel of the interpolated frame from the allocated vector;
a second-prediction-coefficient selection section selecting a prediction coefficient having been obtained in advance for each motion class determined by the second-motion-class determination section and minimizing an error between a student image corresponding to the image signal having the low frequency and a teacher image corresponding to the image signal having the high frequency;
a second-prediction-tap selection section selecting a plurality of pixels located in the surroundings of the pixel of the interpolated frame at least from the student image; and
a second calculation section calculating a prediction coefficient selected by the second-prediction-coefficient selection section and the plurality of pixels selected by the second-prediction-tap selection section to generate a pixel of the interpolated frame.

5. A method of converting a frame frequency, the method comprising the steps of:
inputting a first frame and a second frame of an image signal having a low frequency and estimating a plurality of candidate vectors indicating motions between the first frame and the second frame;
generating a predicted pixel of a predicted frame corresponding to the second frame for each of the candidate vectors from a pixel determined by the estimated candidate vector;
obtaining a correlation between the individual predicted pixel of the predicted frame and a pixel of the second frame and selecting a candidate vector of a predicted pixel having a high value in the correlation;
allocating the selected candidate vector to an individual pixel of an interpolated frame interpolating the first frame and the second frame to determine the vector to be an allocated vector;
allocating a neighboring allocated vector to a pixel of the interpolated frame to which the allocated vector has not been allocated by the motion allocation section; and
generating a pixel of the interpolated frame from a pixel determined by the allocated vector and outputting an image signal having a high frequency.

6. A program for causing a computer to perform a method of converting a frame frequency, the method comprising the steps of:
inputting a first frame and a second frame of an image signal having a low frequency and estimating a plurality of candidate vectors indicating motions between the first frame and the second frame;
generating a predicted pixel of a predicted frame corresponding to the second frame for each of the candidate vectors from a pixel determined by the estimated candidate vector;
obtaining a correlation between the individual predicted pixel of the predicted frame and a pixel of the second frame and selecting a candidate vector of a predicted pixel having a high value in the correlation;
allocating the selected candidate vector to an individual pixel of an interpolated frame interpolating the first frame and the second frame to determine the vector to be an allocated vector;
allocating a neighboring allocated vector to a pixel of the interpolated frame to which the allocated vector has not been allocated by the motion allocation section; and
generating a pixel of the interpolated frame from a pixel determined by the allocated vector and outputting an image signal having a high frequency.

7. A computer readable recording medium recording a program for causing a computer to perform a method of converting a frame frequency, the method comprising the steps of:
inputting a first frame and a second frame of an image signal having a low frequency and estimating a plurality of candidate vectors indicating motions between the first frame and the second frame;
generating a predicted pixel of a predicted frame corresponding to the second frame for each of the candidate vectors from a pixel determined by the estimated candidate vector;
obtaining a correlation between the individual predicted pixel of the predicted frame and a pixel of the second frame and selecting a candidate vector of a predicted pixel having a high value in the correlation;
allocating the selected candidate vector to an individual pixel of an interpolated frame interpolating the first frame and the second frame to determine the vector to be an allocated vector;
allocating a neighboring allocated vector to a pixel of the interpolated frame to which the allocated vector has not been allocated by the motion allocation section; and
generating a pixel of the interpolated frame from a pixel determined by the allocated vector and outputting an image signal having a high frequency.

8. A motion-vector detection apparatus comprising:
a motion-estimation section inputting a first frame and a second frame of an image signal having a low frequency and estimating a plurality of candidate vectors indicating motions between the first frame and the second frame;
a first-motion-class determination section determining a motion class including a predicted pixel of a predicted frame corresponding to the second frame from the candidate vector;
a first-prediction-coefficient selection section selecting a prediction coefficient having been obtained in advance for each motion class determined by the first-motion-class determination section and minimizing an error between a student image corresponding to the predicted frame and a teacher image corresponding to the second frame;
a first-prediction-tap selection section selecting a plurality of pixels located in the surroundings of the predicted pixel of the predicted frame at least from the first frame;
a first calculation section calculating a prediction coefficient selected by the first-prediction-coefficient selection section and the plurality of pixels selected by the first-prediction-tap selection section to generate a predicted pixel of the predicted frame; and
a motion allocation section obtaining a correlation between individual predicted pixel of the predicted frame and a pixel of the second frame, and detecting a candidate vector of the predicted pixel having a high correlation to be a motion vector.

9. A prediction-coefficient generation apparatus comprising:
a motion-estimation section inputting a first frame and a second frame of an image signal having a low frequency and estimating a plurality of candidate vectors indicating motions between the first frame and the second frame;
a motion-class determination section determining a motion class including a predicted pixel of a predicted frame corresponding to the second frame as a teacher image from the motion vector;
a prediction-tap selection section selecting a plurality of pixels located in the surroundings of the predicted pixel of the predicted frame at least from the first frame as a student image; and
a prediction-coefficient generation section obtaining a prediction coefficient minimizing an error between a plurality of pixels in the student image and pixels of the teacher image for each motion class from the motion class detected by the motion-class determination section, the plurality of pixels of the student image selected by the prediction-tap selection section, and the pixels of the teacher image.
